(19) United States
(12) Patent Application Publication
(10) Pub. No.: US 2008/0104007 A1
(43) Pub. Date: May 1, 2008

(54) Distributed clustering method

(76) Inventor: Jerzy Bala, Potomac Falls, VA (US)

Correspondence Address: SEYFARTH SHAW LLP, 131 S. DEARBORN ST., SUITE 2400, CHICAGO, IL, 60603-5803, US

(21) Appl. No.: 11/904,982

(22) Filed: Sep. 28, 2007

Related U.S. Application Data
(63) Continuation-in-part of application No. 10/616,718, filed on Jul. 10, 2003, now Pat. No. 7,308,436.
(60) Provisional application No. 60/848,091, filed on Sep. 29, 2006.

(51) Int. Cl. G06F 17/00

(52) U.S. Cl. 706/59

(57) ABSTRACT

A method for distributed data clustering is provided. The method includes the steps of providing data points each having at least one attribute, determining a two class set of data including data to be clustered and non-cluster data, determining an overall best attribute selection from each of a plurality of clustering agents whereby the overall best attribute selection has the highest overall information gain containing data to be clustered, creating a rule based on the overall best attribute, splitting the data points into at least two groups, creating a plurality of subsets wherein each subset contains data from only one class and outputting complete rules whereby the data points are all located in the subsets.

### CROSS-REFERENCE TO RELATED APPLICATION

This present application claims priority to U.S. Provisional Patent Application Ser. No. 60/848,091, to Bala, filed Sep. 29, 2006, entitled “INFERCLUSTER: A PRIVACY PRESERVING DISTRIBUTED CLUSTERING ALGORITHM.” The present application is also a continuation-in-part of U.S. application Ser. No. 10/616,718, filed Jul. 10, 2003, entitled “DISTRIBUTED DATA MINING AND COMPRESSION METHOD AND SYSTEM.”

### FIELD OF THE INVENTION

This invention relates generally to methods for classifying data, and in more particular applications, to data clustering methods.

### BACKGROUND

Data clustering methods generally relate to data classifying methods whereby common data types are grouped together to form one or more data clusters. Generally, there are two main types of clustering techniques—partitional clustering and hierarchical clustering. Partitional clustering involves determining a partitioning of data records into “k” groups or clusters such that the data records in a specific cluster are more similar or nearer to one another than the data records in different clusters. Hierarchical clustering involves a nested sequence of partitions such that it keeps merging the closest (or splitting the farthest) groups of data records to form clusters.

Clustering from non-distributed data has been studied extensively and reported. For example, clustering and statistics has been described in P. Arabie and L. J. Hubert. “An overview of combinatorial data analysis.” In P. Arabie, L. Hubert, and G. D. Soets, editors, Clustering and Classification, pages 5-63, 1996. Clustering and pattern recognition has been discussed in K. Fukunaga. Introduction to statistical pattern recognition, Academic Press, 1990. Clustering and machine learning has been discussed in D. Fisher. “Knowledge acquisition via incremental conceptual clustering.” Machine Learning, 2:139-172, 1987.

Most of the existing distributed data clustering techniques assume that all data can be collected on a single host machine and represented by a homogeneous and relational structure. This assumption is not very realistic in today's distributed data collection computing systems. Thus, there have been a number of efforts in the research community directed towards distributed data clustering. Unfortunately, the problem with most of these efforts is that although they allow the databases to be distributed over a network, they assume that the data in all of the databases is defined over the same set of features. In other words they assume that the data is partitioned horizontally. In order to fully take advantage of all the available data, the distributed data clustering algorithms must have a mechanism for integrating data from a wide variety of data sources and should be able to handle data characterized by: spatial (or logical) distribution, complexity and multi feature representations, and vertical partitioning/distribution of feature sets.

### SUMMARY

In one form, a method for distributed data clustering is provided. The method includes the steps of providing data points each having at least one attribute, determining a two class set of data including data to be clustered and non-cluster data or synthetic, determining an overall best attribute selection from each of a plurality of clustering agents whereby the overall best attribute selection has the highest overall information gain containing data to be clustered, creating a rule based on the overall best attribute, splitting the data points into at least two groups, creating a plurality of subsets wherein each subset contains data from only one class and outputting complete rules whereby the data points are all located in the subsets.

According to one form, a method for distributed data clustering is provided. The method includes the steps of invoking a plurality of clustering agents at different data locales by a mediator, beginning attribute selection by the plurality of clustering agents, wherein each of the agents determines a best attribute selection that has the highest local information gain value among all attributes to differentiate cluster data from non-cluster data, passing the best attribute from each of the plurality of clustering agents to the mediator, selecting a winning clustering agent from said plurality of agents by said mediator, the winning clustering agent having the best attribute having the highest global information gain, initiating data splitting by the winning agent, forwarding split data index information resulting from the data splitting by the winning agent to the mediator, forwarding the split data index information from the mediator to each of the plurality of clustering agents, initiating data splitting by each of the plurality of clustering agents other than the winning clustering agent, generating and saving partial rules and outputting complete rules to the plurality of clustering agents.

In one form, the rules are created by a decision tree classification.

According to one form, the steps of determining an overall best attribute, creating a rule and splitting the data points are performed in an iterative manner such that each subset contains data from only one class.

In one form, the data to be clustered is in data dense regions and the non-cluster data are in empty or sparse regions.

According to one form, the non-cluster data is synthetic data.

In one form, a system for distributed data clustering is provided. The system includes at least one memory unit having a plurality of data points and a plurality of processing units. The plurality of processing units are used for determining a two class set of data including data to be clustered and non-cluster data, determining an overall best attribute selection from each of a plurality of clustering agents whereby the overall best attribute selection has the highest overall information gain containing data to be clustered, creating a rule based on the overall best attribute, splitting the data points into at least two groups, creating a plurality of subsets wherein each subset contains data from only one class and outputting complete rules whereby the data points are all located in the subsets.

Other forms are also contemplated as understood by those skilled in the art.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its constructions and operation, and many of its advantages should be readily understood and appreciated.

FIG. 1 is a diagrammatic representation of one form of method for data clustering;

FIG. 2 is a diagrammatic representation of communication between an agent and a mediator regarding the discovery of data clusters;

FIG. 3 is a diagrammatic representation of one form of a distributed data mining method and system; and

FIG. 4 is a diagrammatic representation of an agent-mediator communication mechanism.

### DETAILED DESCRIPTION

Clustering refers to the partitioning of a set of objects in groups (clusters) such that objects within the same group are more similar to each other than objects in different groups. The data in each cluster (ideally) share some common trait, often proximity according to some defined distance measure. Clustering is often called unsupervised learning because no classes denoting an a priori partition of the objects are known.

In one form, the method is concerned with scenarios where data to be clustered is collected at distributed databases and cannot be directly centralized or unified as a single file or database due to a variety of constraints (e.g., bandwidth limitations, ownership and privacy issues, limited central storage, etc).

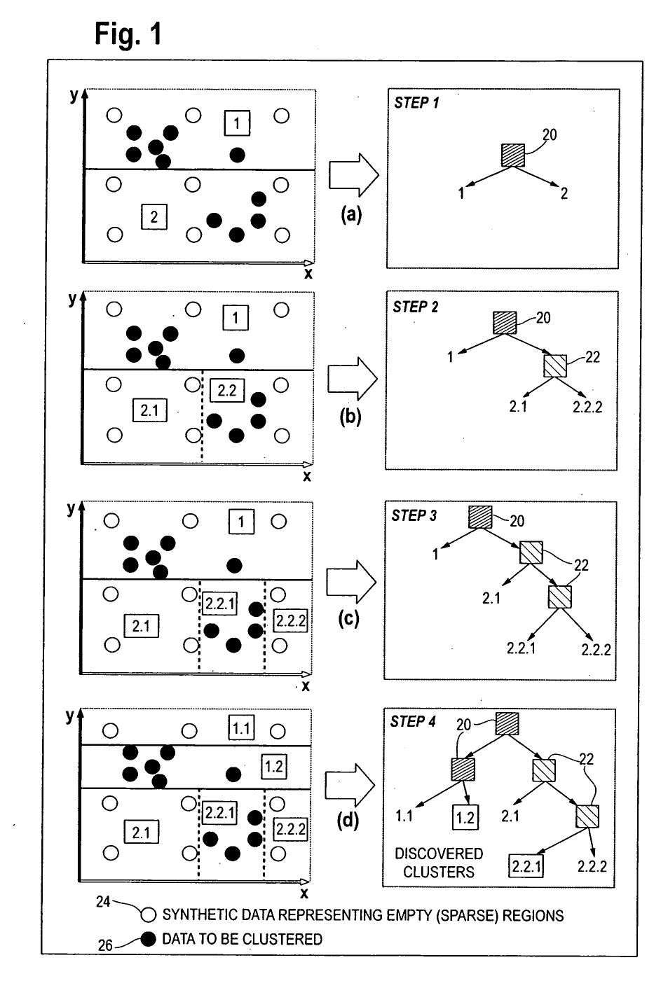

FIG. 1 depicts one form of the distributed clustering method. There are two distributed data locales (x and y coordinates of the distributed representation space). As illustrated in FIG. 1, the data locales each contain one or more agents 20,22 and contain data to be clustered 24 (shown as darker shaded circles) and synthetic data 26 (shown as lighter shaded circles). It should be understood that in one form, the synthetic data 26 is non-cluster data. Additionally, in one form, the synthetic data 26 are uniformly distributed in the representation space to differentiate the synthetic data 26 from the data to be clustered 24.

The method starts by generating the synthetic data points 26 representing empty (sparse) regions by uniformly distributing them in the representation space. Clustering agents 20,22 on each site of the data locales (x and y coordinates), use their accessible data definitions (x and y coordinates) and find the first best partition separating data to be clustered 24 from the synthetic data 26. The quality measures on the best local partitions are computed using information gain parameters and are sent to a mediator component. This mediator component compares all quality measures and decides which one is globally the most optimal one. Following this determination, the mediation component instructs the agent 20,22 with the best partition quality measure to split the data. For example, in FIG. 1(a) the agent 20 at a first data locale splits the data 24,26. After the data is partitioned, the data partitioning agent broadcasts indices on the data split to other agents (i.e., in FIG. 1(a), agent 20 sends indices to agent 22 at another data locale). This step results in generation of two partitions, denoted “1” and “2” in FIG. 1(a).

In the next step, the agents 20,22 collaborate on further splitting of the “2” partition. In FIG. 1(b), two additional partitions, “2.1” and “2.2”, are generated by the contributing agent, in this case, agent 22. This process is repeated/iterated until all data points to be clustered 24 are consistently and completely “enclosed” inside partitions (i.e., in FIG. 1(d), the cluster partitions are “1.2” and “2.2.1”).

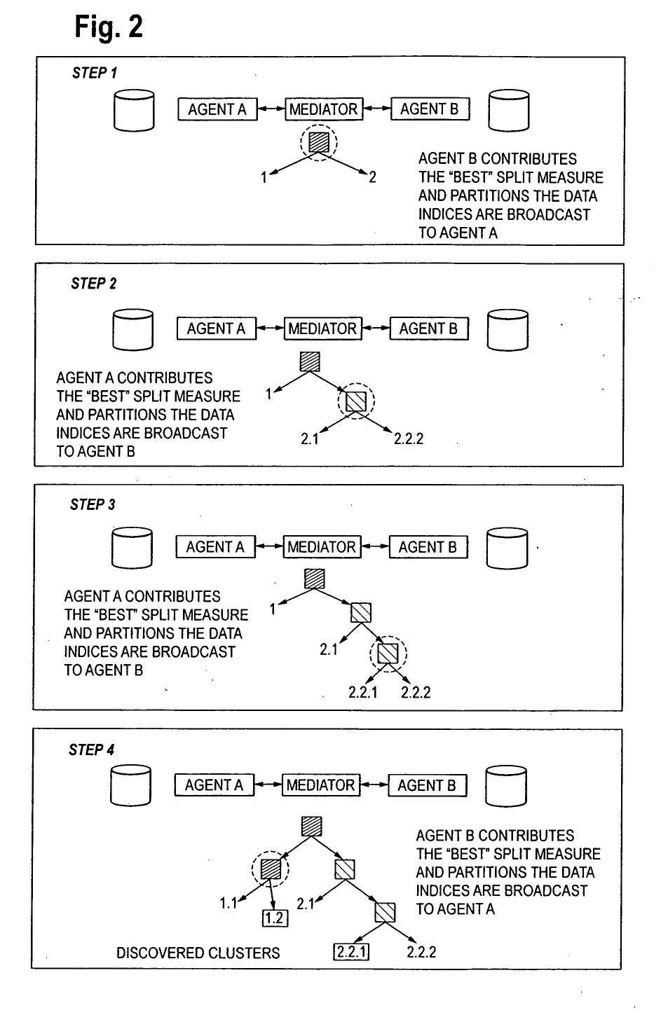

FIG. 2 represents another form of the clustering method. In one form, the method executes the following steps:

Step 1. Agent B contributes the “best” split measure and partitions the data. Data indices are broadcast to Agent A which generates partitions: “1” and “2”.

Step 2. Agent A contributes the “best” split measure and partitions the data within the partition “2”. Data indices are broadcast to Agent B which generates partitions: “2.1” and “2.2”.

Step 3. Agent A contributes the “best” split measure and partitions the data within partition “2.2”. Data indices are broadcast to Agent B which generates partitions: “2.21” and “2.22”. Partition “2.2.2” is a cluster partition.

Step 4. Agent B contributes the “best” split measure and partitions the data within partition “1”. Data indices are broadcast to Agent A which generates partitions: “1.1” and “1.2”. Partition “1.2” is a cluster partition.

Distributed Data Mining

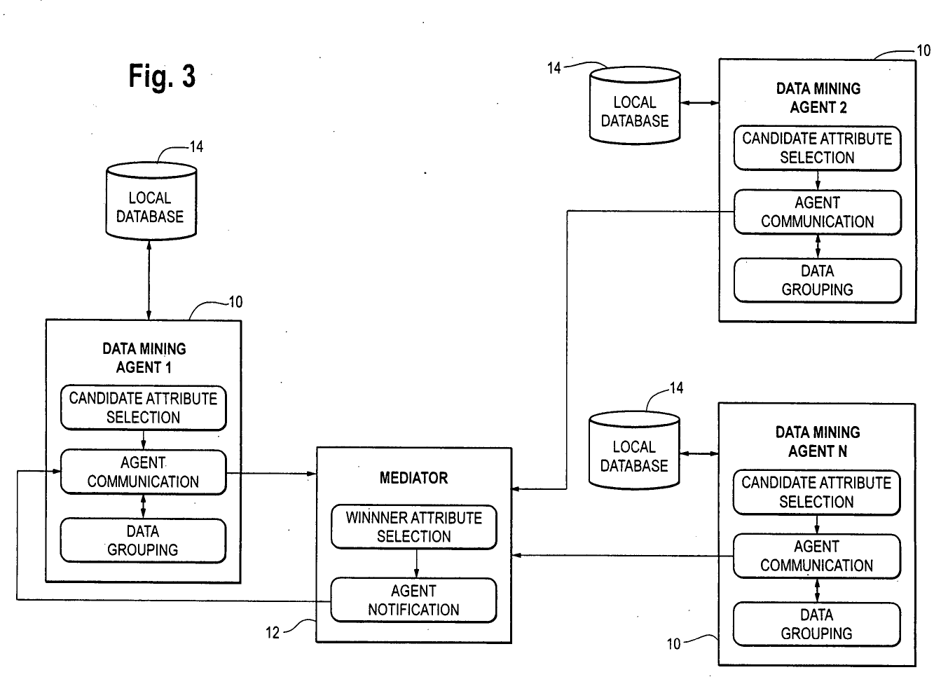

In one form, distributed data mining is utilized as part of the clustering method. FIG. 3 illustrates one basic form of distributed data mining. Distributed mining is accomplished via a synchronized collaboration of agents 10 as well as a mediator component 12. (see Hadjarian A., Baik, S., Bala J., Manthorne C. (2001) “InferAgent—A Decision Tree Induction From Distributed Data Algorithm,” 5th World Multiconference on Systemics, Cybernetics and Informatics (SCI 2001) and 7th International Conference on Information Systems Analysis and Synthesis (ISAS 2001), Orlando, Fla.). The mediator component 12 facilitates the communication among agents 10. In one form, each agent 10 has access to its own local database 14 and is responsible for mining the data contained by the database 14.

Distributed data mining results in a set of rules generated through a tree induction algorithm. The tree induction algorithm, in an iterative fashion, determines the feature which is most discriminatory and then it dichotomizes (splits) the data into a two class set, a class representing data to be clustered and a class representing synthetic data. The next significant feature of each of the subsets is then used to further partition them and the process is repeated recursively until each of the subsets contain only one kind of labeled data (cluster or non-cluster data). The resulting structure is called a decision tree, where nodes stand for feature discrimination tests, while their exit branches stand for those subclasses of labeled examples satisfying the test. A tree is rewritten to a collection of rules, one for each leaf in the tree. Every path from the root of a tree to a leaf gives one initial rule. The left-hand side of the rule contains all the conditions established by the path and thus describe the cluster. In one form, the rules are extracted from a decision tree.

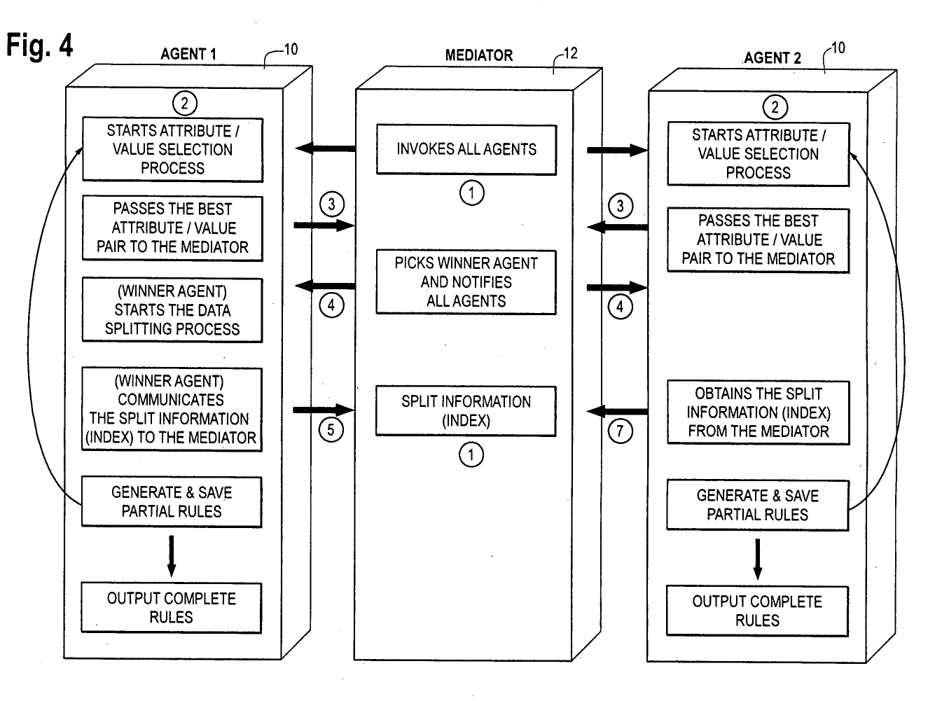

In the distributed framework, tree induction is accomplished through a partial tree generation process and an Agent-Mediator communication mechanism, such as shown in FIG. 4 that executes the following steps:

1. Clustering starts with the mediator 12 issuing a call to all the agents 10 to start the mining process.

2. Each agent 10 then starts the process of mining its own local data by finding the feature (or attribute) that can best split the data into cluster and non-cluster classes (i.e. the attribute with the highest information gain).

3. The selected attribute is then sent as a candidate attribute to the mediator 12 for overall evaluation.

4. Once the mediator 12 has collected the candidate attributes of all the agents 10, it can then select the attribute with the highest information gain as the winner.

5. The winner agent 10 (i.e. the agent whose database includes the attribute with the highest information gain) will then continue the mining process by splitting the data using the winning attribute and its associated split value. This split results in the formation of two separate clusters of data (i.e. those satisfying the split criteria and those not satisfying it).

6. The associated indices of the data in each cluster are passed to the mediator 12 to be used by all the other agents 10.

7. The other (i.e. non-winner) agents 10 access the index information passed to the mediator 12 by the winner agent 10 and split their data accordingly. The mining process then continues by repeating the process of candidate feature selection by each of the agents 10.

8. Meanwhile, the mediator 12 is generating the classification rules by tracking the attribute/split information coming from the various mining agents 10. The generated rules can then be passed on to the various agents 10 for the purpose of presenting them to the user through advanced 3D visualization techniques.

Clustering has become an increasingly essential Business Intelligence task in domains such as marketing and purchasing assistance, multimedia as well as many others. In many of these areas, the data are originally collected at distributed databases. In order to extract clusters out of these databases the expensive and time-consuming data warehousing step is required, where data are brought together and then clustered.

One exemplary application of one form of the method for clustering data is for marketing products to customers. Different divisions of a company maintain various databases on customers. The databases are owned by multiple parties that guard confidential information contained in each database. For example, the marketing division of a company won't share its data as it contains important strategic information like the customer segments who responded most frequently to high-profile campaigns. The product design division maintains its own database and would like to see the marketing data as they target certain demographics for new product features.

The goal is to cluster the entire distributed data, without actually first pooling this data from the two divisions.

One form of the clustering method can be used to generate cluster descriptions of customer segments across these data sources that will help to answer questions such as: What will customers buy?; What products sell together?; What are the characteristics of customers that are at risk for churning?; What are the characteristics of marketing campaigns that are successful? These questions can be answered by analyzing the rule based descriptions of the clustered data.

The customer databases may also represent different web portals. Users of a web application on a specific portal can follow a variety of paths through the portal. The method and system can analyze distributed data and can find patterns that represent a sequence of pages through the site. Such distributed data represents one or more sequences of visited pages and clock stream elements. These patterns can be analyzed to determine if some paths are more profitable than others.

It should be appreciated that the above example is an application of one form of the present method and system. It should be understood that variations of the method are also contemplated as understood by those skilled in the art. Furthermore, it should be understood that the methods described herein may be embodied in a system, such as a computer, network and the like as understood by those skilled in the art. The system may include one or more processing units, hard drives, RAM, ROM, other forms of memory and other associated structure and features as understood by those skilled in the art. It should be understood that multiple processing units may be used in the system such that one processing units performs certain functions at one data locale, a second processing unit performs certain functions at a second data locale and a third processing unit acts as a mediator.

The matter set forth in the foregoing description and accompanying drawings is offered by way of illustration only and not as a limitation. While particular embodiments have been shown and described, it will be obvious to those skilled in the art that changes and modifications may be made without departing from the broader aspects of applicants' contribution. The actual scope of the protection sought is intended to be defined in the following claims when viewed in their proper perspective based on the prior art.

1. A method for distributed data clustering comprising the steps of:
providing data points each having at least one attribute;
determining a two class set of data including data to be clustered and non-cluster data;
determining an overall best attribute selection from each of a plurality of clustering agents whereby the overall best attribute selection has the highest overall information gain containing data to be clustered;
creating a rule based on the overall best attribute;
splitting the data points into at least two groups;
creating a plurality of subsets wherein each subset contains data from only one class; and
outputting complete rules whereby the data points are all located in the subsets.

2. The method of claim 1 wherein the rules are created by a decision tree classification.

3. The method of claims 1 wherein the steps of determining an overall best attribute, creating a rule and splitting the data points are performed in an iterative manner such that each subset contains data from only one class.

4. The method of claim 1 wherein the data to be clustered is in data dense regions and the non-cluster data are in empty or sparse regions.

5. The method of claim 1 wherein the non-cluster data is synthetic data.

6. A method for distributed data clustering comprising the steps of:
invoking a plurality of clustering agents at different data locales by a mediator;
beginning attribute selection by the plurality of clustering agents, wherein each of the agents determines a best attribute selection that has the highest local information gain value among all attributes to differentiate cluster data from non-cluster data;
passing the best attribute from each of the plurality of clustering agents to the mediator;
selecting a winning clustering agent from said plurality of agents by said mediator, the winning clustering agent having the best attribute having the highest global information gain;
initiating data splitting by the winning agent;
forwarding split data index information resulting from the data splitting by the winning agent to the mediator;
forwarding the split data index information from the mediator to each of the plurality of clustering agents;
initiating data splitting by each of the plurality of clustering agents other than the winning clustering agent;
generating and saving partial rules; and
outputting complete rules to the plurality of clustering agents.

7. The method of claim 6 wherein the rules are created by a decision tree classification.

8. The method of claims 1 wherein the steps are performed in an iterative manner.

9. The method of claim 6 wherein the cluster data is in data dense regions and the non-cluster data is in empty or sparse regions.

10. The method of claim 6 wherein the non-cluster data is synthetic data.

11. A system for distributed data clustering comprising:
at least one memory unit having a plurality of data points; and
a plurality of processing units, the plurality of processing units determining a two class set of data including data to be clustered and non-cluster data, determining an overall best attribute selection from each of a plurality of clustering agents whereby the overall best attribute selection has the highest overall information gain containing data to be clustered, creating a rule based on the overall best attribute, splitting the data points into at least two groups, creating a plurality of subsets wherein each subset contains data from only one class and outputting complete rules whereby the data points are all located in the subsets.
